(19) United States
(12) Patent Application Publication
(10) Pub. No.: US 2024/0352172 A1
(43) Pub. Date: Oct. 24, 2024

(54) RADIATION CURABLE COMPOSITIONS FOR ADDITIVE MANUFACTURING OF PARTS WITH HIGH IMPACT RESISTANCE, HIGH DUCTILITY AND HIGH HEAT RESISTANCE

(71) Applicant: EVONIK OPERATIONS GMBH, Essen (DE)

(72) Inventors: Yili WU, Singapore (SG); Erwin PENG, Singapore (SG); Soumya SARKAR, Singapore (SG); Ma Monica Carlos DELA CRUZ, Singapore (SG); Christel GOH, Singapore (SG); Shao Wen NG, Singapore (SG); Dinesh Kumar BASKER, Singapore (SG)

(73) Assignee: EVONIK OPERATIONS GMBH, Essen (DE)

(21) Appl. No.: 18/686,003

(22) PCT Filed: Aug. 17, 2022
(86) PCT No.: PCT/EP2022/072891

§ 371 Date: Feb. 23, 2024

(30) Foreign Application Priority Data
Aug. 27, 2021 (EP) 21193472.4

(51) Int. Cl. C08F 290/06; B33Y 70/00

(52) U.S. Cl. CPC C08F 290/067; B33Y 70/00

(57) ABSTRACT

A liquid radiation curable composition comprising component a) 20 to 60 weight percent of one or more reactive oligomer(s) containing at least two urethane and/or urea linkages in the backbone and at least two ethylenic unsaturated group(s) which can form polymeric crosslink networks with the other components in the composition in the presence of radicals, anions, nucleophiles or combinations thereof, with a weight average molecular weight (M_{w}) of greater than 3000 g/mol and glass transition temperature T_{g} of the cured reactive oligomer(s) itself is greater than 25° C., component b) 20 to 60 weight percent of one or more reactive oligomer(s) containing at least two urethane and/or urea linkages in the backbone and at least two ethylenic unsaturated group(s) which can form multiple polymeric crosslink networks with the other components in the composition in the presence of radicals, anions, nucleophiles or combinations thereof and with component b) having a weight average molecular weight (M_{w}) average of 1000 g/mol or less and a glass transition temperature T_{g} of the cured reactive oligomer(s) is greater than 130° C., component c) 20 to 60 weight percent of one or more reactive monomer(s) containing at least one ethylenic unsaturated group capable of forming polymeric crosslinked networks with the other components in the composition in the presence of radicals, anions, nucleophiles or combinations thereof, the said reactive monomer(s) having at least one polar group and the glass transition temperature T_{g} of the cured monomer(s) is greater than 50° C., component d) 0.01 to 10 weight percent of one or more photoinitiator(s) capable of producing radicals when irradiated with actinic radiation, component e) 0.01 to 30 weight percent of one or more additive(s) selected from the group consisting of filler(s), pigment(s), dispersant(s), defoamer(s), antioxidant(s), light stabilizer(s), light absorber(s) or radical inhibitor(s), with the provision that the liquid radiation curable composition has a viscosity of no more than 10000 mPa.s at 25° C.

This invention relates to liquid radiation curable compositions suitable for additive manufacturing processes to obtain high impact resistant, high ductility and high heat resistant three-dimensional objects.

Additive manufacturing (AM) technology through a photopolymerization process in which layer-by-layer solidification of liquid resinous materials by means of radiation curing (e.g. UV) to manufacture three- dimensional solid polymeric objects has tremendous potential for direct manufacturing of end-use parts.

Traditional Stereolithography (SLA) materials or Digital Light Processing (DLP) materials are known for their rigid but also brittle properties which are typically associated with low impact strength. Such materials are suitable for prototyping applications only.

Materials with high ductility, high impact resistance and high heat resistance are generally desired for additive manufacturing of end-use functional parts. Currently, commercially available single cure radiation curable liquid resins for SLA/DLP printing technology, are not able to achieve these properties altogether.

The elongation at break measures the material's ductility and indicates the ability to undergo certain deformation before material failure. A material with high ductility will be able to deform and not break under a tensile load. On the other hand, material with low ductility indicates brittleness, and the fracture will occur before the material is deformed under a tensile load. Materials with elongation at break, i.e. >20% typically have good ductility. To complement the elongation at break, impact resistant properties also need to be measured as ductile materials may behave similar to brittle materials under high-energy impact conditions. Therefore, it is essential for ductile materials to also exhibit high impact resistant properties.

Materials with good ductility and/or high impact resistance are usually less crosslinked materials with more soft segments in the backbone of the polymer network. More soft segments, however, result in low heat deflection temperature (HDT). High crosslinked materials on the other hand are associated with high heat deflection temperature (HDT) but low impact resistance and low ductility. Examples for such commercial resins are shown in Table A below.

| | Izod Impact | Elongation | |
|---|---|---|---|
| Single-Cure | Strength Notched | at Break | HDT @0.455 MPa |
| Resin | (J/m) | (%) | (° C.) |
| SLA-01 | 18.7 | 13.0% | 77.5 |
| DLP-01 | 24.0 | 12.0% | 70.0 |
| SLA-02 | 40.0 | 48.0% | 63.0 |
| DLP-02 | 58.3 | 47.6% | 60.0 |

Table A: Example of known commercial single-cure SLA/DLP materials' impact strength, elongation at break at Heat Deflection Temperature HDT @0.455MPa.

Table A shows the properties of commercially available resin compositions for additive manufacturing. Three dimensional objects formed using resin composition SLA-01 (Formlabs resin GreyPro) and DLP-01 (3DSystems PRO-BLK-10) show high heat deflection temperature but low impact strength and low Ductility.

Three dimensional objects formed using resin composition SLA-02 (Formlabs resin Tough2000) and resin composition DLP-02 (Henkel Loctite3D 3843 HDT60 High Toughness) show high impact resistance and high ductility (elongation at break) but low heat deflection temperature. Neither one of those resins can achieve high ductility, high impact resistance and high heat resistance.

Several attempts have been made in the prior art to address this challenge.

JP2020076005A pertains to the use of high molecular weight polymer to increase the impact strength. However, such approach generally will translate into lower heat resistant properties.

U.S. Pat. No. 9,457,515B2 discloses a dual-cure formulation based on epoxy-oxetane chemistry which was used to obtain cured article with izod impact strength (notched) between 30-60 J/m and heat deflection temperature properties (HDT) at 0.45 MPa of less than 65° C.

U.S. Pat. No. 20,200,157258A1 discloses highly cross-linked cured articles using trifunctional isocyanurate components. Although the heat deflection temperature and charpy impact strength are improved, the cured articles have insufficient elongation at break.

EP1551890B1 discloses dual-cure formulations based on epoxy-oxetane chemistry which can attain a heat deflection temperature at 1.8MPa of above 105° C. EP1551890B1 is silent regarding impact resistance properties but elongation at break generally is less than 5%, making the materials too brittle.

There are still some limitations or challenges associated with the approaches presented in the prior art as those approaches are mostly addressing either impact strength or heat deflection temperature properties separately. Typical resin formulation would result in significant improvement in one of the properties (i.e. elongation at break, izod impact strength or heat deflection temperature) while sacrificing other properties.

As shown above, the three properties are currently not achieved simultaneously, leaving the cured printed article either with high impact properties or high heat resistance properties, but not both. In addition to this, the materials ductility typically represented by tensile properties (i.e. elongation at break) is often disregarded from the properties. Alternative routes towards high impact resistant materials that have high heat resistance (HDT) and high ductility continue to be much needed.

It is therefore an object of this invention to provide a liquid radiation curable composition suitable for additive manufacturing applications in which the disadvantages of prior art materials are at least reduced and which provides a sufficient degree of impact resistance while not compromising heat resistance and ductility.

The object of this invention is achieved by a liquid radiation curable composition comprising:
component a) 20 to 60 weight percent of one or more reactive oligomer(s) containing at least two urethane and/or urea linkages in the backbone and at least two ethylenic unsaturated group(s) which can form polymeric crosslinked networks with the other components in the composition in the presence of radicals, anions, nucleophiles or combinations thereof and with a weight average molecular weight (M_{w}) of at least 3000 g/mol and a glass transition temperature of the cured reactive oligomer(s) itself is greater than 25° C.
component b) 20 to 60 weight percent of one or more reactive oligomer(s) containing at least two urethane and/or urea linkages in the backbone and at least two ethylenic unsaturated group(s) which can form polymeric crosslinked networks with the other components in the composition in the presence of radicals, anions, nucleophiles or combinations thereof and with component b) having a weight average molecular weight (M_{w}) of 1000 g/mol or less and a glass transition temperature of the cured reactive oligomer(s) greater than 130° C.
component c) 20 to 60 weight percent of one or more reactive monomer(s) containing at least one ethylenic unsaturated group capable of forming polymeric crosslinked networks with the other components in the composition in the presence of radicals, anions, nucleophiles or combinations thereof, the said reactive monomer having at least one polar group and the glass transition temperature of the cured monomer(s) is greater than 50° C.
component d) 0.01 to 10 weight percent of one or more photoinitiator(s) capable of producing radicals when irradiated with actinic radiation,
component e) 0.01 to 30 weight percent of one or more additive(s) selected from the group consisting of filler(s), pigment(s), dispersant(s), defoamer(s), antioxidant(s), light stabilizer(s), light absorber(s) or radical inhibitor(s),
with the provision that the liquid radiation curable composition has a viscosity of no more than 10000 mPa.s at 25° C.

The sum of components a) to e) equals 100 weight percent.

The viscosity is measured using a rotational rheometer equipped with cone plate (2°) at 25° C. and reading is obtained at 1 Hz shear rate.

The term “oligomers” is used synonymous with the term pre-polymer or polymer. As used herein oligomer means intermediate of a polymerization reaction that involves two or more components.

The oligomer of component a) can be linear and it may have side chains. The urethane linkages are preferably located in the linear part of the oligomer.

The weight average molecular weights (M_{w}) of component a) and component b) are determined by gel permeation chromatography (GPC) measurement using tetrahydrofuran (THF) as eluent with PS/DVB (polystyrene divinylbenzene) column (size: 4.6 mm I.D.×15 cm, particle size: 3μm) and PS/DVB (polystyrene divinylbenzene) guard column (size: 4.6 mm I.D.×2 cm, particle size: 4μm) at a temperature of 40° C. and a flow rate of 0.35 mL/min with refractive index detector. The sample concentration is 5 to 6 mg/mL in THF with injection amount of 20 μL. The weight average molecular weights are calculated relative to polystyrene standard.

The term “ethylenic unsaturated group” refers to a vinyl, allyl, itaconate or a (meth)acrylate group

The term “(meth)acrylate group” means either a methacrylate group, an acrylate group or a mixture of both.

Component a) preferably contains 2 to 4 ethylenic unsaturated groups, more preferably 2 or 3 ethylenic unsaturated groups and most preferably 2 (two) ethylenic unsaturated groups.

Preferably the weight average molecular weight (M_{w}) of component a) ranges from 3000 to 10000 g/mol, more preferably 3000 to 8000 g/mol and most preferably 3000 to 6000 g/mol.

The T_{g} is determined in accordance with ASTM D3418.

The glass transition temperature of the cured reactive oligomer(s) of component a) preferably ranges from 25° C. to 80° C., more preferably from 25° C. to 60° C.

Component a) is most preferably an aliphatic or aromatic diurethane di(meth)acrylate with a weight average molecular weight (M_{w}) of greater than 3000 g/mol and a glass transition temperature of the cured reactive oligomer greater than 25° C.

Component b) preferably contains 2 to 4 ethylenic unsaturated groups, more preferably 2 or 3 ethylenic unsaturated groups and most preferably 2 (two) ethylenic unsaturated groups.

Preferably the weight average molecular weight (M_{w}) of component b) ranges from 300 g/mol to 1000 g/mol, more preferably 300 g/mol to 800 g/mol and most preferably 300 to 600 g/mol. The glass transition temperature of the cured reactive oligomer(s) of component b) preferably ranges from 130° C. to 180° C., more preferably from 130° C. to 160° C.

The liquid radiation curable composition according to the invention preferably has a viscosity of 8000 mPa.s at 25° C. or less, more preferably 6000 mPa.s at 25° C. or less and most preferably 4000 mPa.s at 25° C. or less.

Surprisingly it could be shown that the liquid radiation curable composition according to the invention can be used in additive manufacturing processes to obtain three-dimensional objects with high impact, high heat deflection properties and high ductility. The liquid radiation curable composition comprises a unique reactive oligomer(s) as component a). The inventive combination of this new reactive oligomer(s) with the other components yields a composition that allows to form three-dimensional objects with high impact resistant, high heat resistant and high ductility. Neither one of these properties will be sacrificed to improve one of the other properties.

The compositions according to the invention result in three-dimensional objects with an elongation at break of greater than 20% (ASTM D638), Izod impact strength (notched) of greater than 40 J/m (ASTM D256) and heat deflection temperature (HDT) at an applied stress of 0.45 MPa (66 psi) of greater than 70° C. (ASTM D648). Dimensions of the printed three-dimensional objects are designed in accordance with ASTM D638, ASTM D256 and ASTM D648. Measurements were carried out after washing as well as UV and/or thermal post-curing.

Three-dimensional objects and the corresponding radiation curable liquid resin formulations such objects are produced from are superior than the current products in the market, setting a new benchmark for single cure formulations resulting in good ductility, high impact resistance and high heat resistance. Such balanced properties would enable the three-dimensional objects produced (i) to be rigid, yet be able to be deformed/bend slightly (which allows use e.g. in snap-fit applications), (ii) to withstand high-energy impact which enables the materials to resist cracking and/or breaking upon hitting another rigid object (e.g. dropping or bumping action) and (iii) to be able to withstand temperatures above 70° C. which would enable many engineering applications (e.g. automotive parts).

The radiation curable compositions according to the invention can therefore be used for additive manufacturing of end-use consumer functional parts.

In a preferred embodiment of the invention the liquid radiation curable composition is characterized in that the urethane and/or urea linkages in the reactive oligomer(s) of component a) are obtained by reacting aliphatic or aromatic diisocyanate with one or more long chain polyols or diamines and with one or more short chain polyols or diamines to form a hydroxyl-terminated or isocyanate-terminated polyurethane/urea intermediate.

The term “short chain polyols or diamines” as used herein means the weight average molecular weight (M_{w}) of the short chain polyol or diamine is less than 300 g/mol. Preferably the short chain polyols or diamines have a weight average molecular weight (M_{w}) of less than 280 g/mol, more preferably less than 260 g/mol.

The term “long chain polyol or diamine” as used herein means the weight average molecular weight (M_{w}) of the long chain polyol or diamine is greater or equal than 300 g/mol. Preferably the long chain polyols or diamines have a weight average molecular weight (M_{w}) of greater than 350 g/mol, more preferably greater than 400 g/mol.

The hydroxyl-terminated polyurethane/urea intermediate is then preferably reacted with an isocyanate-functionalized (meth)acrylate. If an isocyanate-terminated polyurethane/urea intermediate is obtained, then said isocyanate-terminated polyurethane/urea intermediate is reacted with a hydroxyl-functionalized (meth)acrylate to form component a). Due to the reaction with one or more long chain polyols or diamines and with one or more short chain polyols or diamines the resulting intermediate as well as component a) comprises a hard segment and a soft segment.

In general, polyurethane/urea is a class of block copolymer(s) that comprises both a soft segment (SS) and hard segment (HS) which are chemically connected.

The soft segment generally refers to the blocks or segments with lower polarity, long chain and flexible properties while hard segment generally refers to block or segments with higher polarity, short chain and bulky structure (Szycher's Handbook of Polyurethanes, 2^{nd} Edition, 2013). The soft segments, typically a reaction product of diisocyanates with long chain polyols (also termed macro-diols which can be based on polyesters, polyethers, polycarbonates, polybutadienes, polyisobutylenes, or poly(dimethylsiloxane)) and/or poly-diamines, are rich in—CH₂—which enables rotation of carbon-carbon bonds which allow backbone flexibility.

The hard segment which consist of low molecular weight chain extender that are typically the reaction product of diisocyanates with short chain polyols and/or diamines enabling the urethane/urea linkages to be closely packed which inhibits the configuration change. The hard segment will contribute to the thermoplastic properties and the mechanical strength of the chain (Sidney Goodman's Handbook of Thermoset Plastics, 3^{rd} edition, Chapter 9, 2014).

Component a) of the liquid radiation curable composition according to the invention is preferably characterized in that the molar ratio between soft and hard segment of component a) is greater or equal than 0.5. Most preferably, the molar ratio between soft and hard segment of component a) is preferred to be between 0.5 to 2. Such molar ratio would further improve balanced thermo-mechanical properties when formulated with component b) and component c) according to the invention.

According to the invention a new design of chemistry was developed that can achieve printed parts with high impact resistance, high heat resistance and good ductility. The liquid radiation curable composition preferably comprises one or more urethane di(meth)acrylate oligomers, one or more diurethane dimethacrylate oligomers, one co-monomer with hydroxy functional group, photoinitiator and optionally other additives like fillers or stabilizers. The preferred urethane di(meth)acrylate oligomer which represents component a) according to the invention comprises multiple urethane/urea linkages which is a reaction product of diisocyanate, polyol/diamine with hydroxyl-containing monofunctional di(meth)acrylate. The reaction results in an oligomer with a weight average molecular weight M_{w} greater than 3000 g/mol and with glass transition temperature T_{g} of the cured reactive oligomer itself of greater than 25° C.

Component b) is preferably a diurethane dimethacrylate oligomer with multiple urethane linkages which is a reaction product of diisocyanate with hydroxyl-containing monofunctional dimethacrylate. The reaction results in a diurethane dimethacrylate oligomer with a weight average molecular weight M_{w} of less than 1000 g/mol and glass transition temperature T_{g} of the cured reactive oligomer itself greater than 130° C.

In another preferred embodiment of the liquid radiation curable composition according to the invention the hydroxyl-terminated polyurethane/urea intermediate is reacted with an isocyanate-functionalized (meth)acrylate or the isocyanate-terminated polyurethane/urea intermediate is reacted with a hydroxyl-terminated (meth)acrylate to form a component a) according to the following structure

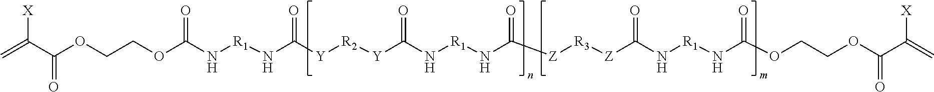

### Component a) Polyurethane (Meth)Acrylate Reactive Oligomer

R₁ is a hydrocarbon residue formed by the reaction of isocyanate with polyol or diamine, R₂ is a hydrocarbon residue formed by the reaction of isocyanate with a long chain polyol or diamine, R₃ is a hydrocarbon residue formed by the reaction of isocyanate with short chain polyol or diamine, X is either H or CH₃, Y is either O or NH and Z is either O or NH. Y can be the same or different than Z. n is an integer ranging from 1 to 100. m is an integer ranging from 0 to 100.

As mentioned above, the urethane and/or urea linkages in the reactive oligomer(s) of component a) are preferably obtained by reacting aliphatic or aromatic diisocyanate with one or more long chain polyols or diamines and with one or more short chain polyols or diamines to form a hydroxyl-terminated or isocyanate-terminated polyurethane/urea intermediate. The aliphatic and aromatic diisocyanates are preferably selected from the group consisting of 5-Isocyanato-1-(isocyanatomethyl)-1,3,3-trimethylcyclohexane (isophorone diisocyanate), 1,6-diisocyanatohexane, 1,3-Bis(2-isocyanatopropan-2-yl)benzene, 2,2,4-trimethylhexane diisocyanate, 2,4,4-trimethylhexane diisocyanate, pentane diisocyanate, 4,4′-methylene bis(cyclohexyl isocyanate), 4-Methyl-1,3-phenylene diisocyanate, 2,2′-methylenebis(phenyl isocyanate), 2,4′-methylenebis(phenyl isocyanate), 4,4′-methylenebis(phenyl isocyanate) or mixtures thereof.

The one or more long chain polyols or diamines are preferably selected from polyether or polyester backbone to form a soft segment and the one or more short chain polyols or diamines are selected from polyether or polyester backbone to form a hard segment.

In another preferred embodiment of the liquid radiation curable composition according to the invention the urethane linkages in the one or more reactive oligomer(s) of component b) are obtained by reacting aliphatic or aromatic isocyanate with hydroxyl-terminated methacrylates to form component b) according to the following structure:

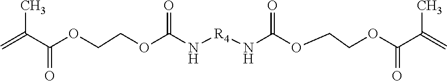

### Component b) Urethane Methacrylate Reactive Oligomer

R₄ is a hydrocarbon residue formed by the reaction of isocyanate with polyol that can be the same or different than R₁ for component a) above.

The aliphatic or aromatic isocyanates that are reacted with hydroxyl-terminated (meth)acrylates to form component b) above are preferably selected from the group consisting of 5-Isocyanato-1-(isocyanatomethyl)-1,3,3-trimethylcyclohexane (isophorone diisocyanate), 1,6-diisocyanatohexane, 1,3-Bis(2-isocyanatopropan-2-yl)benzene, 2,2,4-trimethylhexane diisocyanate, 2,4,4′-trimethylhexane diisocyanate, pentane diisocyanate, 4,4′-methylene bis(cyclohexyl isocyanate), 4-Methyl-1,3-phenylene diisocyanate, 2,2′-methylenebis(phenyl isocyanate), 2,4′-methylenebis(phenyl isocyanate), 4,4′-methylenebis(phenyl isocyanate) or mixtures thereof.

Most preferably component b) is selected from the group consisting of
HEMAIPDI: 2-Propenoic acid, 2-methyl-, 2-(((((1,3,3-trimethyl-5-(((2-((2-methyl-1-oxo-2-propen-1-yl)oxy)ethoxy)carbonyl)amino)cyclohexyl)methyl)amino)carbonyl)oxy)ethyl ester,
HEMATMDI: Di-2-methacryloxyethyl 2,2,4-trimethyl hexamethylenedicarbamate,
HEMATDI: 2-Methyl-acrylic acid 2-(3-isocyanato-4-methyl-phenylcarbamoyloxy)-ethyl ester (3-Isocyanato-4-methyl-phenyl)-carbamidsaeure-(2-methacryloyloxyethylester),
HEMAMDI: 2-Propenoic acid, 2-methyl-, methylenebis(4,1-phenyleneiminocarbonyloxy-2,1-ethanediyl) ester (9Cl); 1,1′-[Methylenebis(4,1-phenyleneiminocarbonyloxy-2,1-ethanediyl)]bis(2-methyl-2-propenoate).

The reactive monomer(s) of component c) of the liquid radiation curable composition according to the invention having at least one polar group selected from the group consisting of hydroxy, carboxy, urethane or urea.

The liquid radiation curable composition according to the invention preferably comprises a component c) that is characterized in that the at least one ethylenic unsaturated group of the monomer in component c) is a (meth)acrylate functional group and the monomer of component c) further comprises:
a hydrocarbon group selected from C2-C30 linear, cyclic, branched, aliphatic, aromatic, alicyclic or cycloaliphatic group and
a hydrocarbon group that carries polar functional groups selected from the group consisting of hydroxy, carboxy, urethane or urea.

Most preferably component c) is selected from the group consisting of 2-hydroxyethyl methacrylate, hydroxypropyl methacrylate, glycerol monomethacrylate and 2-carboxylethyl (meth)acrylate.

In yet another preferred embodiment of the invention the liquid radiation curable composition is characterized in that the total content of urethane and urea linkage contributed by component a) and component b) is greater than 1.5 mmol per gram of liquid radiation curable composition. The total content of urethane and urea linkage can be determined from calculation if the chemical structure is known. Otherwise, the chemical structure can be determined from Fourier-transform infrared spectroscopy (FTIR) or nuclear magnetic resonance spectroscopy (NMR) and then the urethane and urea content can be calculated accordingly.

Component d) in the liquid radiation curable resin composition according to the invention is a photoinitiator capable of producing radicals when irradiated with actinic radiation. Preferably component d) is a free radical photoinitiator, more preferably the free radical photoinitiator is an aromatic ketone type photoinitiator or a phosphine oxide type photoinitiator.

Aromatic ketone type photoinitiators are preferably selected from the group consisting of 1-hydroxycyclohexyl phenyl ketone, 2-hydroxy-l-(4-(4-(2-hydroxy-2-methylpropionyl) benzyl)phenyl-2-methylpropan-1-one, 2-hydroxy-2-methyl-1-phenylpropanone, 2-hydroxy-2-methyl-l-(4-isopropylphenyl)propanone, oligo(2-hydroxy-2-methyl-1-(4-(1-methylvinyl)phenyl)propanone, 2-hydroxy-2-methyl-1-(4-dodecylphenyl)propanone, 2-hydroxy-2-methyl-l-[(2-hydroxyethoxy)phenyl]propanone, benzophenone, substituted benzophenones, 2,2-Dimethoxy-1,2-diphenylethanone or mixtures thereof.

Phosphine type photoinitiators are preferably selected from the group consisting of diphenyl(2,4,6-trimethylbenzoyl) phosphine oxide (TPO), phenylbis(2,4,6-trimethylbenzoyl) phosphine oxide (BAPO) or Ethyl phenyl(2,4,6-trimethylbenzoyl)phosphinate (TPO-L) or mixtures thereof.

The amount of photoinitiator added to the liquid curable formulation ranges from 0.01% to 10% weight of the total liquid formulation. The photoinitiator(s) are capable of producing radicals when irradiated with actinic radiation. Preferably the actinic radiation source irradiating the said photoinitiator is a mercury lamp, a LED source or even a LCD source that has an emission wavelength between 230 nm to 600 nm.

The liquid, radiation curable resin composition according to the invention may comprise 0.01 to 30 weight percent of one or more additive(s) as component e). Component e) is selected from the group consisting of filler(s), pigment(s), dispersant(s), defoamer(s), antioxidant(s), light stabilizer(s), light absorber(s) or radical inhibitor(s).

Filler(s) may be inorganic or organic particles or mixtures of both. Preferably filler(s) are nano-sized to micron-sized inorganic particles selected from the group consisting of silica, alumina, zirconia, titania or mixtures thereof. In case the filler(s) include organic particles, such nano-sized to micron-sized organic particles are selected from the group consisting of poly(methyl methacrylate), poly(vinyl alcohol), poly(vinyl butyrate), polyamide, polyimide or mixtures thereof.

Pigment(s) may include carbon black and organic dye or colorants which are able to provide color to otherwise clear or blank liquid mixture.

Dispersant(s) or dispersing agents are used to improve the stabilization of fillers and pigments in the liquid mixture. The dispersant(s) are preferably selected from the group consisting of Tego Dispers 685, Tego Dispers 650, Tego Dispers 652, Tego Dispers 655, Tego Dispers 656, Tego Dispers 689, Tego Dispers 673, Tego Dispers 1010, Tego Dispers 670, Tego Dispers 688, Tego Dispers 676, Tego Dispers 690, Tego Variplus LK, BYK-220S, BYK-9076, BYK-9077, BYKJET-9150, BYKJET-9151, DISPERBYK-101 N, DISPERBYK-163, DISPERBYK-163 TF, DISPERBYK-164, DISPERBYK-2001, DISPERBYK-2117, DISPERBYK-2118, DISPERBYK-2155, DISPERBYK-2155 TF, DISPERBYK-2200, Efka PX 4310, Efka PX 4320, Efka PX 4731, Efka PX 4732, Efka PX 4733, Efka PX 4787.

Defoamer(s) or anti-foaming agents can be added to reduce and hinder the formation of foam when process liquids. As defoamer for example Tego Airex 920 and Tego Airex 921 can be used.

Anti-oxidants can be added to provide long-term thermal stabilization, preventing oxidation of the three-dimensional printed object. Anti-oxidants are preferably selected from the group consisting of phenolic antioxidants, phosphite antioxidants, thioester antioxidants, aminic antioxidants or mixtures thereof. Other suitable anti-oxidants are, for example 1,3,5-Trimethyl-2,4,6-tris(3,5-di-tert-butyl-4-hydroxybenzyl)benzene, Calcium bis(ethyl 3,5-di-tert-butyl-4-hydroxybenzylphosphonate), 1,3,5-Tris(3,5-di-tert-butyl-4-hydroxybenzyl)-1,3,5-triazinane-2,4,6-trione, Bis[4-(2-phenyl-2-propyl)phenyl]amine, 2-(1-(2-Hydroxy-3,5-di-tert-pentyl-phenyl)ethyl)-4,6-di-tert-pentylphenyl acrylate, 4-((4,6-Bis(octylthio)-1,3,5-triazin-2-yl)amino)-2,6-di-tert-butylphenol or mixtures thereof.

Light absorbers are preferably selected from the group consisting of Ethyl 4-[[(methylphenylamino) methylene]amino], 2-(2-hydroxyphenyl)-benzotriazole, 2-(4,6-Bis-(2,4-dimethylphenyl)-1,3,5-triazin-2-yl)-5-(octyloxy)-phenol, 2-(4,6-diphenyl-1,3,5-triazin-2-yl)-5-[(hexyl)oxy]-phenol, 2-(2H-benzotriazol-2-yl)-4,6-bis(1-methyl-1-phenylethyl)phenol, 2,2-Bis(((2-cyano-3,3-diphenylacryloyl)oxy)methyl)propane-1,3-diyl bis(2-cyano-3,3-diphenylacrylate), ethyl 2-cyano-3,3-diphenylacrylate, 2-ethylhexyl 2-cyano-3,3-diphenylacrylate, 2-(3-tert-butyl-2-hydroxy-5-methylphenyl)-5-chlorobenzotriazole, 2-(2H-Benzotriazol-2-yl)-4-(1,1,3,3-tetramethylbutyl)phenol, 2,2′-Methylenebis[6-(2H-benzotriazol-2-yl)-4-(1,1,3,3-tetramethylbutyl)phenol], 2,2′-(1,4-Phenylene)bis[4H -3, 1-Benzoxazin-4-one] 2-[4-(4-oxo-4H-3,1-benzoxazin-2-yl)phenyl]-4H-3,1-benzoxazin-4-one, 2-(2H-Benzothiazol-2-yl)-6-dodecyl-4-methylphenol, branched and linear, 2-Hydroxy-4-n-octyloxybenzophenone, 2-hydroxy-4-methoxybenzophenone, 2-(2H-Benzotriazol-2-yl)-6-(1-methyl-1-phenylethyl)-4-(1,1,3,3-tetramethylbutyl)phenol, 2-(2H-benzotriazol-2-yl)-p-cresol, 2-isopropylthioxanthone, 1-phenylazo-2-naphtol as well as optical brightener such as 2,5-bis-(5-tert-butyl-2-benzoxazolyl) thiophene, 4,4′-bis(2-methoxystyryl)-1,1′-biphenyl. or mixtures thereof.

In some embodiments, the light stabilizer is selected from the group consisting of 1,5,8,12-Tetrakis[4,6-bis(N-butyl-N-1,2,2,6,6-pentamethyl-4-piperidylamino)-1,3,5-triazin-2-yl]-1,5,8,12-tetraazadodecane, 4-Hydroxy-2,2,6,6-tetramethylpiperidine-1-oxyl, Bis(1-octyloxy-2,2,6,6-tetramethyl-4-piperidyl) sebacate, 2,2,6,6-Tetramethyl-4-piperidinol; reaction mass of Bis(1,2,2,6,6-pentamethyl-4-piperidyl) sebacate and Methyl 1,2,2,6,6-pentamethyl-4-piperidyl sebacate, 1-methyl 1,2,2,6,6-pentamethylpiperidin-4-yl decanedioate bis(1,2,2,6,6-pentamethylpiperidin-4-yl) decanedioate, Poly[N,N′-bis(2,2,6,6-tetramethyl -4-piperidinyl)-1,6-hexanediamine-co-2,4-dichloro-6-morpholino-1,3,5-triazine], 1,6-hexanediylbis[N-(2,2,6,6-tetramethyl-4-piperidinyl), bis(2,2,6,6,-tetramethyl-4-piperidyl)sebacate; bis(2,2,6,6-tetramethyl-1-(octyloxy)-4-piperidinyl) ester; bis (1,2,2,6, 6-pentamethyl-4-piperidinyl)-[[3,5-bis(1,1-dimethylethyl)-4-hydroxyphenyl]methyl] butylmalonate or mixtures thereof.

A polymerization or radical inhibitor can be added to provide additional thermal stability. Suitable radical inhibitors are methoxyhydroquinone (MEHQ) or various aryl compounds like butylated hydroxytoluene (BHT).

In another preferred embodiment of the invention the liquid radiation curable composition comprises:
component a) 20 to 60 weight percent of one or more reactive oligomer(s) containing at least two urethane and/or urea linkages in the backbone and two ethylenic unsaturated group(s) which can form polymeric crosslinked networks with the other components in the composition in the presence of radicals, anions, nucleophiles or combinations thereof and with a weight average molecular weight (M_{w}) of at least 3000 g/mol and a glass transition temperature of the cured reactive oligomer(s) itself is greater than 25° C.;
component b) 20 to 60 weight percent of one or more reactive oligomer(s) containing at least two urethane and/or urea linkages in the backbone and two ethylenic unsaturated group(s) which can form multiple polymeric crosslinked networks with the other components in the composition in the presence of radicals, anions, nucleophiles or combinations thereof and with component b) having a weight average molecular weight (M_{w}) of 1000 g/mol or less and a glass transition temperature of the cured reactive oligomer(s) greater than 130° C.
component c) 20 to 60 weight percent of one or more reactive monomer(s) containing at least one ethylenic unsaturated group capable of forming polymeric crosslinked networks with the other components in the composition in the presence of radicals, anions, nucleophiles or combinations thereof, the said reactive monomer having at least one polar group and the glass transition temperature of the cured monomer(s) is greater than 50° C.;
component d) 0.01 to 10 weight percent of one or more photoinitiator(s) capable of producing radicals when irradiated with actinic radiation;
component e) 0.01 to 30 weight percent of one or more additive(s) selected from the group consisting of filler(s), pigment(s), dispersant(s), defoamer(s), antioxidant(s), light stabilizer(s), light absorber(s) or radical inhibitor(s).
with the provision that the liquid radiation curable composition has a viscosity of no more than 10000 mPa.s at 25° C.

In another preferred embodiment of the invention the liquid radiation curable composition comprises:
component a) 20 to 60 weight percent of reactive oligomers according to the following structure

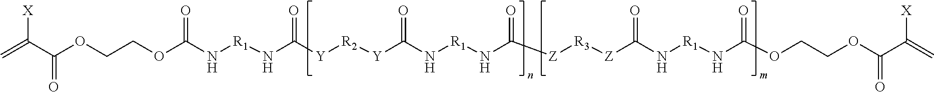

### Component a) Polyurethane (Meth)Acrylate Reactive Oligomer

With the provision that R₁ is a hydrocarbon residue from the reaction of isocyanate with polyol or diamine, R₂ is a hydrocarbon residue formed by the reaction of isocyanate with a long chain polyol or diamine, R₃ is a hydrocarbon residue formed by the reaction of isocyanate with short chain polyol or diamine, X is either H or CH_{3,} Y is either O or NH and Z is either O or NH and Y can be the same or different than Z, n is an integer ranging from 1 to 100, m is an integer ranging from 0 to 100. Component a) has a weight average molecular weight (M_{w}) of at least 3000 g/mol and a glass transition temperature of the cured reactive oligomer(s) itself is greater than 25° C.;
component b) 20 to 60 weight percent of reactive oligomers according to the following structure

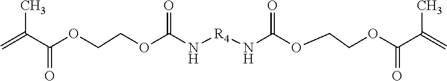

### Component b) Urethane Methacrylate Reactive Oligomer

R₄ is a hydrocarbon residue formed by the reaction of isocyanate with polyol that can be the same or different than R₁ for component a) above and with component b) having a weight average molecular weight (M_{w}) of 1000 g/mol or less and a glass transition temperature of the cured reactive oligomer(s) greater than 130° C.
component c) 20 to 60 weight percent of one or more reactive monomer(s) containing at least one ethylenic unsaturated group capable of forming polymeric crosslinked networks with the other components in the composition in the presence of radicals, anions, nucleophiles or combinations thereof, the said reactive monomer having at least one polar group and the glass transition temperature of the cured monomer(s) is greater than 50° C.;
component d) 0.01 to 10 weight percent of one or more photoinitiator(s) capable of producing radicals when irradiated with actinic radiation;
component e) 0.01 to 30 weight percent of one or more additive(s) selected from the group consisting of filler(s), pigment(s), dispersant(s), defoamer(s), antioxidant(s), light stabilizer(s), light absorber(s) or radical inhibitor(s);
with the provision that the liquid radiation curable composition has a viscosity of no more than 10000 mPa.s at 25° C.

In another preferred embodiment of the invention the liquid radiation curable composition comprises:
component a) 20 to 60 weight percent an aliphatic or aromatic diurethane di(meth)acrylate with a weight average molecular weight (M_{w}) of at least 3000 g/mol and a glass transition temperature of the cured aliphatic or aromatic diurethane di (meth) acrylate is greater than 25° C.;
component b) 20 to 60 weight percent of one or more reactive oligomer(s) selected from the group consisting of HEMAIPDI: 2-Propenoic acid, 2-methyl-, 2-(((((1,3,3-trimethyl-5-(((2-((2-methyl-1-oxo-2-propen-1-yl)oxy)ethoxy)carbonyl)amino)cyclohexyl)methyl)amino)carbonyl)oxy)ethyl ester, HEMATMDI: Di-2-methacryloxyethyl 2,2,4-trimethyl hexamethylenedicarbamate, HEMATDI: 2-Methyl-acrylic acid 2-(3-isocyanato-4-methyl-phenylcarbamoyloxy)-ethyl ester (3-Isocyanato-4-methyl-phenyl)-carbamidsaeure-(2-methacryloyloxyethylester) and HEMAMDI: 2-Propenoic acid, 2-methyl-, methylenebis(4,1-phenyleneiminocarbonyloxy-2,1-ethanediyl) ester (9Cl); 1,1′-[Methylenebis(4,1-phenyleneiminocarbonyloxy-2,1-ethanediyl)] bis(2-methyl-2-propenoate).
component c) 20 to 60 weight percent of one or more reactive monomer(s) containing at least one ethylenic unsaturated group capable of forming polymeric crosslinked networks with the other components in the composition in the presence of radicals, anions, nucleophiles or combinations thereof, the said reactive monomer having at least one polar group and the glass transition temperature of the cured monomer(s) is greater than 50° C.;
component d) 0.01 to 10 weight percent of one or more photoinitiator(s) capable of producing radicals when irradiated with actinic radiation;
component e) 0.01 to 30 weight percent of one or more additive(s) selected from the group consisting of filler(s), pigment(s), dispersant(s), defoamer(s), antioxidant(s), light stabilizer(s), light absorber(s) or radical inhibitor(s);
with the provision that the liquid radiation curable composition has a viscosity of no more than 10000 mPa.s at 25° C.

In another preferred embodiment of the invention the liquid radiation curable composition comprises:
component a) 20 to 60 weight percent an aliphatic or aromatic diurethane di(meth)acrylate with a weight average molecular weight (M_{w}) of at least 3000 g/mol and a glass transition temperature of the cured aliphatic or aromatic diurethane di meth)acrylate is greater than 25° C.;
component b) 20 to 60 weight percent of one or more reactive oligomer(s) selected from the group consisting of HEMAIPDI: 2-Propenoic acid, 2-methyl-, 2-(((((1,3,3-trimethyl-5-(((2-((2-methyl-1-oxo-2-propen-1-yl)oxy)ethoxy)carbonyl)amino)cyclohexyl)methyl)amino)carbonyl)oxy)ethyl ester,

HEMATMDI: Di-2-methacryloxyethyl 2,2,4-trimethyl hexamethylenedicarbamate, HEMATDI: 2-Methyl-acrylic acid 2-(3-isocyanato-4-methyl-phenylcarbamoyloxy)-ethyl ester (3-Isocyanato-4-methyl-phenyl)-carbamidsaeure-(2-methacryloyloxyethylester) and HEMAMDI: 2-Propenoic acid, 2-methyl-, methylenebis(4,1-phenyleneiminocarbonyloxy-2,1-ethanediyl) ester (9Cl); 1,1′-[Methylenebis(4,1-phenyleneiminocarbonyloxy-2,1-ethanediyl)] bis(2-methyl-2-propenoate).
component c) 20 to 60 weight percent of one or more reactive monomer(s) selected from the group consisting of 2-hydroxyethyl methacrylate, hydroxypropyl methacrylate, glycerol monomethacrylate and 2-carboxylethyl (meth)acrylate;
component d) 0.01 to 10 weight percent of one or more photoinitiator(s) capable of producing radicals when irradiated with actinic radiation;
component e) 0.01 to 30 weight percent of one or more additive(s) selected from the group consisting of filler(s), pigment(s), dispersant(s), defoamer(s), antioxidant(s), light stabilizer(s), light absorber(s) or radical inhibitor(s);
with the provision that the liquid radiation curable composition has a viscosity of no more than 10000 mPa.s at 25° C.

The liquid radiation curable composition according to the invention is especially suitable to be used in an additive manufacturing process. Such an additive manufacturing process usually comprises the repeated steps of deposition or layering and irradiating the composition to form a three-dimensional object.

Irradiation can be provided by a UV or DLP light engine. In a preferred embodiment of the invention, the total actinic irradiation dose required for the curing of the liquid radiation curable composition per layer is greater than 30 mJ/cm² per layer 100 μm layer thickness. The total actinic irradiation dose can be up to 300 mJ/cm² for a 100 μm layer thickness print setting. Preferably if the total actinic irradiation is between 30 mJ/cm² and 120 mJ/cm² at 100 μm layer thickness. More preferably if the total actinic irradiation is between 30 mJ/cm² and 80 mJ/cm² at 100 μm layer thickness. For a commercial DLP 3D printer that has light intensity of 10 mW/cm^{2, 30} mJ/cm² per layer is equivalent to 3 seconds of total irradiation process per layer curing. When other layer thickness print setting is used (e.g. 10 μm, 20 μm and 50 μm), the total actinic irradiation dose required for the curing of the liquid radiation curable composition per layer must be scaled accordingly.

The term “DLP” or “digital light processing” refers to an additive manufacturing process in which a three-dimensional object is formed by curing the liquid radiation curable resins using actinic irradiation into solid objects by means of DLP display device based on optical micro-electro-mechanical technology that uses a digital micromirror device.

The additive manufacturing process that uses the liquid radiation curable composition according to the invention may comprise additional process steps like cleaning, washing, sonication, additional dosage of radiation, heating, polishing, coating or combinations thereof.

Unexpectedly, it was found that the liquid, radiation curable resin composition according to the invention attains three-dimensional objects with balanced properties of the fully cured product. Prior art resins can attain cured objects that have either high ductility, high impact strength or high heat resistance. Improving either one of these properties attenuates at least one of the other properties. The liquid, radiation curable resin composition according to the invention attains cured objects superior to those prior art resins as all of the above-mentioned properties are on a high level and neither ductility, impact strength or heat resistance is attenuated.

Thus, the invention also encompasses a three-dimensional object generated by an additive manufacturing process using the liquid radiation curable composition according to the invention. Such a three-dimensional object printed using the liquid radiation curable composition according to the invention exhibits:
an Izod impact strength (notched) of 40 J/m to 140 J/m according to ASTM D256,
an elongation at break of 20% to 50% according to ASTM D638,
a heat deflection temperature (HDT) at 0.455 MPa of 70° C. to 100° C. according to ASTM D648.

The radiation curable liquid resin formulations according to the invention produce three-dimensional objects with balanced properties superior to the current products in the market and unexpectedly setting a new benchmark for single cure formulation. The radiation curable liquid resin formulations are suitable to be used for additive manufacturing of end-use consumer functional parts.

In another aspect of the present invention three-dimensional objects generated by an additive manufacturing process using the liquid radiation curable composition according to the invention demonstrates isotropic behavior.

The three-dimensional objects can be printed in various orientation such as XY direction, YZ direction, XZ direction, Z direction and other custom direction where an angle is selected against any of the X, Y and Z planes. According to this aspect of the invention, the elongation at break in XY direction (parallel to the build platform) and in Z direction (perpendicular to the build platform) as determined by ASTM D638 method differs not more than 20% from each other.

### EXAMPLES

The subject matter of the present invention is illustrated in more detail in the following examples, without any intention that the subject matter of the present invention be restricted to these examples.

The liquid radiation curable resin composition is prepared by mixing the ingredients as mentioned in the tables below in a mixing equipment.

Component a) can be a commercially available substance or it can be prepared prior to mixing the components of the resin. Preparation of component a) is exemplified with component a) encoded “EP01”: 21.1 g of isophorone diisocyanate (IPDI) was added to 117.6 g of 2-hydroxyethyl methacrylate (2-HEMA) in a round bottom flask immersed in a water-bath. To this stirring IPDI solution in 2-HEMA, 79.7 g polyoxypropylenediamine was added dropwise while ensuring temperature does not heat up beyond 70° C. Subsequently, 4.6 g hexamethylenediamine (HMDA) was added dropwise while ensuring temperature does not heat up beyond 70° C. Upon completion of addition of diamines, 0.1 g dibutyltin dilaurate was added and the mixture was then incubated at 70° C. for 2 hours. The resulting component a is diluted in 2-HEMA at 49.7 wt %.

Glass transition temperature T_{g} was determined in accordance to ASTM D3418. Specifically, the glass transition temperature was obtained by differential scanning calorimetry (DSC) measurement. Samples were prepared by mixing 15 g of component a) or b) with 0.3 g TPO-L photoinitiator and homogenizing with speed-mixer (3000 RPM for 10 minutes). The resin was casted on a simple PTFE mold and labelled thin clear plastic sheet and UV cured using curing unit with heating function (intensity >80 mW/cm²; 405 nm wavelength) at 60° C. for 30 minutes. The casted and cured resin was cut into smaller pieces (<10 mg) and loaded into T_{zero} pan (aluminium). The pan was loaded into a calorimeter.

The weight average molecular weight was determined by gel permeation chromatography (GPC) measurement (TOSOH). The GPC was performed in tetrahydrofuran (THF) as eluent with PS/DVB (polystyrene divinylbenzene) column (size: 4.6 mm I.D.×15 cm, particle size: 3 μm) and PS/DVB (polystyrene divinylbenzene) guard column (size: 4.6 mm I.D.×2 cm, particle size: 4 μm) at a temperature of 40° C. and a flow rate of 0.35 mL/min with refractive index detector. The sample concentration is 5 to 6 mg/mL in THF with injection amount of 20 μL. The weight average molecular weights were calculated relative to polystyrene standard.

The viscosity of the final liquid radiation curable composition is measured using rotational rheometer equipped with cone plate (2°) and reading is obtained at 1 Hz shear rate. Unless otherwise indicated viscosity is measured at a temperature of 25° C.

The thus prepared resin composition is used to generate printed specimens through DLP 3D printing process at layer height thickness setting of 100 μm and an actinic irradiation between 30 and 80 mJ/cm².per 100 μm layer thickness.

Elongation at break of the printed, washed and UV post-cured specimen was determined according to ASTM D638, Izod impact strength (notched) of the printed, washed and UV post-cured specimen was determined according to ASTM D256 and heat deflection temperature (HDT) of the printed, washed and UV post-cured specimen is measured at an applied stress of 0.45 MPa (66 psi) according to ASTM D648 Method B.

Table B summarizes the abbreviations used for substances in the following examples.

TABLE B
Abbreviation of the monomers

| Abbreviation | Description |
|---|---|
| HEMATMDI | Di-2-methacryloxyethyl 2,2,4-trimethyl |
| | hexamethylenedicarbamate |
| Bis-GMA | Bisphenol A-glycidyl |
| | dimethacrylate |
| TCDDMMA | Tricyclodecane dimethanol |
| | dimethacrylate |
| GLYFOMA | Glycerol formal methacrylate |
| BAPO | Phenylbis(2,4,6-trimethylbenzoyl)phosphine |
| | oxide |
| TPO-L | Ethyl(2,4,6-Trimethylbenzoyl)-Phenyl |
| | Phosphinate |

### EXAMPLE 1

Example 1 encompasses liquid radiation curable composition 1A. Composition 1A comprises as component a) an aliphatic urethane dimethacrylate (EP01) with a weight average molecular weight of more than 3500 g/mol and a glass transition temperature of more than 35° C.

TABLE 1
Composition 1A for liquid radiation curable resin for 3D printing

| Composition | | 1A | |
|---|---|---|---|
| Component a) | EP01 (Aliphatic Urethane Dimethacrylate) | 34.65 | wt % |
| Component b) | HEMATMDI | 34.65 | wt % |
| Component c) | 2-HEMA | 29.71 | wt % |
| Component d) | BAPO (Photoinitiator) | 0.99 | wt % |

| | |
|---|---|
| Elongation at Break [%] | 21.9 |
| HDT [° C.] | 86.3 |
| Izod impact strength J/m | ≥40.0 |

The viscosity of the composition 1A was 6203 mPa.s at 25° C. and therefore within the required range of less than 10000 mPa.s at 25° C.

A printed specimen of Composition 1A according to the invention shows an elongation at break above 20%, a heat reflection temperature above 70° C. The printed specimen showed an Izod impact strength (notched) greater than 40 J/m.

### Example 2

Example 2 encompasses liquid radiation curable compositions 2A and 2B. Composition 2A comprises as component a) an aliphatic urethane diacrylate (EP02) with a weight average molecular weight of 3669 g/mol and a glass transition temperature of 28.98° C. Composition 2B comprises as component a) an aliphatic urethane diacrylate (EP03) with a weight average molecular weight of 4698 g/mol and a glass transition temperature of 42.34° C.

TABLE 2
Compositions 2A, 2B for liquid radiation curable resin for 3D printing

| Composition | | 2A | | 2B | |
|---|---|---|---|---|---|
| Component a) | EP02 (Aliphatic Urethane Diacrylate) | 34.65 | wt % | — | |
| Component a) | EP03 (Aliphatic Urethane Diacrylate) | — | | 34.65 | wt % |
| Component b) | HEMATMDI | 34.65 | wt % | 34.65 | wt % |
| Component c) | 2-HEMA | 29.71 | wt % | 29.71 | wt % |
| Component d) | BAPO (Photoinitiator) | 0.99 | wt % | 0.99 | wt % |

| | | |
|---|---|---|
| Elongation at Break [%] | 26.0 | 38.3 |
| HDT [° C.] | 78.6 | 83.3 |
| Izod impact strength J/m | 43.4 | 61.1 |

The viscosity of the composition 2A was 961 mPa.s at 25° C. and composition 2B was 1800 mPa.s at 25° C. Both compositions were therefore within the required range of less than 10000 mPa.s at 25° C.

Printed specimens of Composition 2A and 2B according to the invention show an elongation at break, a heat reflection temperature and Izod impact strength within the required ranges of an elongation at break of 20% to 50% measured according to ASTM D638, a heat deflection temperature (HDT) at 0.455 mPa of 70° C. to 100° C. according to ASTM D648 and an Izod impact strength in the range of 40 J/m to 140 J/m measured according to ASTM D256.

### Example 3

Compositions 3A and 3B are comparative examples using different components a). Composition 3A comprises as component a) an aromatic urethane diacrylate (EP04) with a weight average molecular weight of 2609 g/mol and a glass transition temperature of 14.82° C. Composition 3B comprises as component a) an aliphatic urethane diacrylate (EP05) with a weight average molecular weight of 1346 g/mol and a glass transition temperature of 23.72° C. Components a) of compositions 3A and 3B do not have the required weight average molecular weight (M_{w}) of greater than 3000 g/mol and the glass transition temperature is also not greater than 25° C.

TABLE 3
Compositions 3A and 3B for liquid radiation curable resin for 3D printing

| Composition | | 3A | | 3B | |
|---|---|---|---|---|---|
| Component a) | EP04 (Aromatic Urethane Diacrylate) | 34.65 | wt % | — | |
| Component a) | EP05 (Aliphatic Urethane Diacrylate) | — | | 34.65 | wt % |
| Component b) | HEMATMDI | 34.65 | wt % | 34.65 | wt % |
| Component c) | 2-HEMA | 29.71 | wt % | 29.71 | wt % |
| Component d) | BAPO (Photoinitiator) | 0.99 | wt % | 0.99 | wt % |

| | | |
|---|---|---|
| Elongation at Break [%] | 34.3 | 17.3 |
| HDT [° C.] | 63.5 | — |
| Izod impact strength J/m | 31.1 | 36.1 |

The viscosity of the composition 3A was 706 mPa.s at 25° C., composition 3B was 331 mPa.s at 25° C. All compositions were therefore within the required range of less than 10000 mPa.s at 25° C.

A printed specimen of composition 3A lies in the required range of 20% to 50% of elongation at break but does neither reach the required Izod impact strength of 40 J/m to 140 J/m and neither the heat deflection temperature of 70° C. to 100° C.

A printed specimen of composition 3B lies below the required range of 20% to 50% of elongation at break and it does not reach the required Izod impact strength of 40 J/m to 140 J/m.

### Example 4

Compositions 4A, 4B and 4C are comparative examples with different components b). Comparative Example 4A uses as component b) TCDDMMA and comparative examples 4B and 4C uses BisGMA as component b).

TCDDMMA has a weight average molecular weight (M_{w}) of 332 g/mol and is therefore in the range of less than 1000 g/mol which is required according to the invention. The glass transition temperature of TCDDMMA is 125.31° C. which is lower than the required at least 130° C according to the invention.

BisGMA has a weight average molecular weight (M_{w}) of 513 g/mol which lies in the range of less than 1000 g/mol which is required according to the invention. The glass transition temperature of BisGMA lies at above 150° C. and is therefore in the range of greater than 130° C. as required according to the invention.

Neither one of the two components b), however, contains the required at least two urethane and/or urea linkages according to the invention.

All other components are within the required provisions according to the invention.

TABLE 4
Compositions 4A, 4B and 4C for liquid radiation curable resin for 3D printing

| Composition | | 4A | | 4B | | 4C | |
|---|---|---|---|---|---|---|---|
| Component a) | EP02 (Aliphatic Urethane Diacrylate) | | | | | 34.65 | wt % |
| Component a) | EP03 (Aliphatic Urethane Diacrylate) | 34.65 | wt % | 34.65 | wt % | | |
| Component b) | TCDDMMA | 34.65 | wt % | | | | |
| Component b) | BisGMA | | | 34.65 | wt % | 34.65 | wt % |
| Component c) | 2-HEMA | 29.71 | wt % | 29.71 | wt % | 29.71 | wt % |
| Component d) | BAPO (Photoinitiator) | 0.99 | wt % | 0.99 | wt % | 0.99 | wt % |

| | | | |
|---|---|---|---|
| Elongation at Break [%] | 9.0 | 16.4 | 15.0 |
| HDT [° C.] | 95.2 | 82.7 | 79.2 |
| Izod impact strength J/m | 20.1 | 29.0 | 27.9 |

The viscosity of the composition 4A was 595 mPa.s at 25° C., composition 4B was 3620 mPa.s at 25° C. and composition 4C was 2150 mPa.s at 25° C. All compositions were therefore within the required range of less than 10000 mPa.s at 25° C.

A printed specimen of composition 4A does not reach the required range of 20% to 50% of elongation at break and neither reaches the required Izod impact strength of 40 J/m to 140 J/m. The heat deflection temperature lies in the required range of 70° C. to 100° C.

A printed specimen of composition 4B neither reaches the required range of 20% to 50% of elongation at break nor the required Izod impact strength of 40 J/m to 140 J/m. The heat deflection temperature lies in the required range of 70° C. to 100° C.

A printed specimen of composition 4C neither reaches the required range of 20% to 50% of elongation at break nor the required Izod impact strength of 40 J/m to 140 J/m Only the heat deflection temperature lies in the required range of 70° C. to 100° C.

As all parameters need to be within the required range according to the invention these compositions are not suitable to achieve the unique inventive balanced properties.

### Example 5

Composition 5A is a comparative example using glycerol formal methacrylate (GLYFOMA) as component c). The glass transition temperature of GLYFOMA lies at 80° C. which is in the required range of greater than 50° C. according to the invention. However, GLYFOMA does not have any polar groups such as hydroxyl or carboxyl groups as required according to the invention.

TABLE 5
Compositions for liquid radiation curable resin for 3D printing

| Composition | | 5A | |
|---|---|---|---|
| Component a) | EP02 | 34.65 | wt % |
| Component b) | HEMATMDI | 34.65 | wt % |
| Component c) | GLYFOMA | 29.71 | wt % |
| Component d) | BAPO (Photoinitiator) | 0.99 | wt % |

| | |
|---|---|
| Elongation at Break [%] | 21.9 |
| HDT [° C.] | 76.3 |
| Izod impact strength J/m | 29.2 |

The viscosity of composition 5A was 2400 mPa.s at 25° C. and therefore within the required range of less than 10000 mPa.s at 25° C.

A printed specimen of Composition 5A according to the invention shows an elongation at break above 20% and a heat reflection temperature above 70° C. Izod impact strength, however, is below the required range of 40 J/m to 140 J/m.

The above examples show it is critical that each component of the composition lies within the claimed range according to the invention. Otherwise the targeted unique balanced properties regarding elongation at break, Izod impact strength and heat reflection temperature cannot be achieved. Only the inventive compositions will result in elongation at break (ASTM D638) of greater than 20%, Izod impact strength (notched) (ASTM D256) of greater than 40 J/m and the heat deflection temperature @0.455 MPa (ASTM D648) of greater than 70° C.

### Example 6

TABLE 6
Compositions 2B, printed in XY and Z directions

| Composition 2B | (XY) direction | (Z) direction | Difference (%) |
|---|---|---|---|
| Elongation at Break [%] | 38.3 | 34.6 | 9.7% |

Printed specimens of Composition 2B according to the invention were used to test isotropic behavior. Table 6 shows that the elongation at break of a printed specimen of composition 2B according to the invention is 38.3% in XY direction (parallel to the build platform) and the elongation at break in Z direction (perpendicular to the build platform) is 34.6% determined according to ASTM D638. Elongation at break in XY direction (parallel to the build platform) and in Z direction (perpendicular to the build platform) method differs by 9.7%. The difference in the elongation at break is within the required range of not more than 20% from each other according to the invention.

1-16. (canceled)

17. A liquid radiation curable composition comprising:
component a): 20 to 60 weight percent of one or more reactive oligomer(s) containing at least two urethane and/or urea linkages in the backbone and at least two ethylenic unsaturated group(s) which can form polymeric crosslink networks with the other components in the composition in the presence of radicals, anions, nucleophiles or combinations thereof, with a weight average molecular weight (M_{w}) of greater than 3000 g/mol and wherein the glass transition temperature T_{g} of the cured reactive oligomer(s) is greater than 25° C.;
component b): 20 to 60 weight percent of one or more reactive oligomer(s) containing at least two urethane and/or urea linkages in the backbone and at least two ethylenic unsaturated group(s) which can form polymeric crosslink networks with the other components in the composition in the presence of radicals, anions, nucleophiles or combinations thereof and having a weight average molecular weight (M_{w}) of 1000 g/mol or less and wherein the glass transition temperature T_{g} of the cured reactive oligomer(s) greater than 130° C.;
component c): 20 to 60 weight percent of one or more reactive monomer(s) containing at least one ethylenic unsaturated group capable of forming polymeric crosslinked networks with the other components in the composition in the presence of radicals, anions, nucleophiles or combinations thereof, the reactive monomer(s) having at least one polar group and wherein the glass transition temperature T_{g} of the cured monomer(s) is greater than 50° C.;
component d): 0.01 to 10 weight percent of one or more photoinitiator(s) capable of producing radicals when irradiated with actinic radiation;
component e): 0.01 to 30 weight percent of one or more additive(s) selected from the group consisting of: filler(s), pigment(s), dispersant(s), defoamer(s), antioxidant(s), light stabilizer(s), light absorber(s) and radical inhibitor(s);
with the provisio that the liquid radiation curable composition has a viscosity of no more than 10000 mPa.s at 25° C.

18. The liquid radiation curable composition of claim 17, wherein the viscosity of the composition is less than 8000 mPa.s at 25° C.

19. The liquid radiation curable composition of claim 17, wherein the urethane and/or urea linkages in the reactive oligomer(s) of component a) are obtained by reacting aliphatic or aromatic diisocyanate with one or more long chain polyols or diamines and with one or more short chain polyols or diamines to form a hydroxyl-terminated or isocyanate-terminated polyurethane/urea intermediate.

20. The liquid radiation curable composition of claim 19, wherein the hydroxyl-terminated polyurethane/urea intermediate is reacted with an isocyanate-functionalized (meth)acrylate or the isocyanate-terminated polyurethane/urea intermediate is reacted with a hydroxyl-functionalized (meth)acrylate to form component a) comprising a hard segment and a soft segment.

21. The liquid radiation curable composition of claim 20, wherein the molar ratio between soft and hard segments of component a) is greater or equal than 0.5.

22. The liquid radiation curable composition of claim 19, wherein the hydroxyl-terminated polyurethane/urea intermediate is reacted with an isocyanate-functionalized (meth)acrylate or the isocyanate-terminated polyurethane/urea intermediate is reacted with a hydroxyl-terminated (meth)acrylate to form component a) according to the following structure: 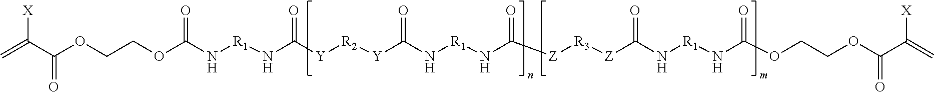
Component a) Polyurethane (meth)acrylate reactive oligomer
wherein R₁ is a hydrocarbon residue from the reaction of isocyanate with polyol or diamine, R₂ is a hydrocarbon residue formed by the reaction of isocyanate with a long chain polyol or diamine, R₃ is a hydrocarbon residue formed by the reaction of isocyanate with a short chain polyol or diamine, X is either H or CH₃, Y is either O or NH and Z is either O or NH;
wherein Y can be the same or different than Z, n is an integer ranging from 1 to 100, and m is an integer ranging from 0 to 100.

23. The liquid radiation curable composition of claim 19, wherein the aliphatic and aromatic diisocyanates are selected from the group consisting of: 5-isocyanato-1-(isocyanatomethyl)-1,3,3-trimethylcyclohexane (isophorone diisocyanate), 1,6-diisocyanatohexane, 1,3-bis(2-isocyanatopropan-2-yl)benzene, 2,2,4-trimethylhexane diisocyanate, 2,4,4-trimethylhexane diisocyanate, pentane diisocyanate, 4,4′-methylene bis(cyclohexyl isocyanate), 4-methyl-1,3-phenylene diisocyanate, 2,2′-methylenebis(phenyl isocyanate), 2,4′-methylenebis(phenyl isocyanate), 4,4′-methylenebis(phenyl isocyanate) and mixtures thereof.

24. The liquid radiation curable composition of claim 19, wherein the one or more long chain polyols or diamines are comprise a polyether or polyester backbone with a weight average molecular weight (M_{w}) greater or equal than 300 g/mol to form a soft segment and the one or more short chain polyols or diamines comprise a polyether or polyester backbone with a weight average molecular weight (M_{w}) less than 300 g/mol to form hard segment.

25. The liquid radiation curable composition of claim 17, wherein the urethane linkages in the one or more reactive oligomer(s) of component b) are obtained by reacting aliphatic or aromatic isocyanate with hydroxyl-terminated methacrylates to form the following structure: 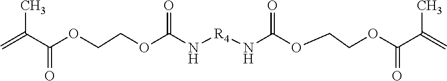
Component b) Urethane methacrylate reactive oligomer(s)
with the provisio that R₄ is a hydrocarbon residue formed by the reaction of isocyanate with polyol and can be the same or different than R₁ for component a).

26. The liquid radiation curable composition of claim 25, wherein the aliphatic or aromatic isocyanates are selected from the group consisting of: 5-isocyanato-1-(isocyanatomethyl)-1,3,3-trimethylcyclohexane (isophorone diisocyanate), 1,6- diisocyanatohexane, 1,3-bis(2-isocyanatopropan-2-yl)benzene, 2,2,4-trimethylhexane diisocyanate, 2,4,4-trimethylhexane diisocyanate, pentane diisocyanate, 4,4′-methylenebis(cyclohexyl isocyanate), 4-Methyl-1,3-phenylene diisocyanate, 2,2′-methylenebis(phenyl isocyanate), 2,4′-methylenebis(phenyl isocyanate), 4,4′-methylenebis(phenyl isocyanate) and mixtures thereof.

27. The liquid radiation curable composition of claim 17, wherein the at least one ethylenic unsaturated group of the monomer in component c) is a (meth)acrylate functional group and the monomer of component c) further comprises:
a hydrocarbon group selected from C₂-C₃₀ linear, cyclic, branched, aliphatic, aromatic, alicyclic or cycloaliphatic groups; and
a hydrocarbon group that carries polar functional groups selected from the group consisting of: hydroxy, carboxy, urethane and urea.

28. The liquid radiation curable composition of claim 17, wherein the total content of urethane and urea linkages contributed by component a) and component b) is greater than 1.5 mmol per gram of liquid radiation curable composition.

29. The liquid radiation curable composition of claim 19, wherein the total content of urethane and urea linkages contributed by component a) and component b) is greater than 1.5 mmol per gram of liquid radiation curable composition.

30. The liquid radiation curable composition of claim 21, wherein the total content of urethane and urea linkages contributed by component a) and component b) is greater than 1.5 mmol per gram of liquid radiation curable composition.

31. The liquid radiation curable composition of claim 23, wherein the total content of urethane and urea linkages contributed by component a) and component b) is greater than 1.5 mmol per gram of liquid radiation curable composition.

32. The liquid radiation curable composition of claim 26, wherein the total content of urethane and urea linkages contributed by component a) and component b) is greater than 1.5 mmol per gram of liquid radiation curable composition.

33. An additive manufacturing process comprising repeatedly depositing or layering the liquid radiation curable composition of claim 17 and irradiating the resulting composition to form a three-dimensional object.

34. The additive manufacturing process of claim 33, wherein the liquid radiation curable composition is treated by one or more further steps of selected from the group consisting of:
cleaning, washing, sonicating, radiating, heating, polishing, coating and combinations thereof.

35. A three-dimensional object formed by an additive manufacturing process using the liquid radiation curable composition of claim 17, wherein the three-dimensional object comprises:
an Izod impact strength of 40 J/m to 140 J/m according to ASTM D256;
an elongation at break of 20% to 50% according to ASTM D638; and
a heat deflection temperature (HDT) at 0.455 MPa of 70° C. to 100° C. according to ASTM D648.

36. The three-dimensional object of claim 35, wherein the elongation at break of the three-dimensional object measured according to ASTM D638 in the XY direction and in the Z direction differs not more than 20% from each other.
